(19) United States
(12) Patent Application Publication
(10) Pub. No.: US 2015/0024079 A1
(43) Pub. Date: Jan. 22, 2015

(54) DOUGH-SKIN FOLDING DEVICE

(71) Applicant: Anko Food Machine Co., Ltd., New Taipe City (TW)

(72) Inventors: YU-CHU WANG, New Taipei City (TW); KAI-PO KAO, New Taipei City (TW); JUI-FENG CHU, New Taipei City (TW)

(21) Appl. No.: 13/944,889

(22) Filed: Jul. 18, 2013

(51) Int. Cl. A21C 9/08; A21C 11/10

(52) U.S. Cl. CPC A21C 9/088; A21C 11/10
USPC 425/202; 425/206

(57) ABSTRACT

The dough-skin folding device contains two or more folding assemblies above a conveyor belt. Each folding assembly contains a base plate and a transmission member beneath the base plate. The transmission member contains pairs of shafts arranged in two rows. Each shaft has a bottom end engaged by a rotatable roller. A pair of the rollers, driven by a power source, makes the other rollers to spin synchronously through transmission belts. A spatula is positioned in front of each folding assembly, and contains a curved blade aligned to the gap between the two rows of rollers. When a dough-skin is moved towards the folding assembles, the dough-skin's lateral sides are scraped up by spatulas and they are folded towards the middle by rollers into a loaf of dough having three layers of dough-skin for subsequent processes. The loaf of dough has multi-level mouthfeel similar to one manually made.

### TECHNICAL FIELD OF THE INVENTION

The present invention is generally related to dough-skin folding devices, and more particular to a dough-skin folding device capable of automatically folding a dough-skin multiple times and blowing air between the folded dough-skin to create enhanced mouthfeel.

### DESCRIPTION OF THE PRIOR ART

Pastry made from flour is a traditional and popular type of food. Usually, flour and water are first mixed and kneaded into a loaf of dough. Then, after green onion, butter, and other ingredients are added, the loaf of dough is cut into small chunks of dough. These chunks are then pressed and flattened into pastry of various shapes. The pastry is then fried or baked into a delicious cake, which is one of the most favored types of food of all people around the world.

For the cake to be delicious, it should deliver a multi-level mouthfeel. Conventionally, after the loaf of dough is cut into small chunks of dough, a skillful chef will repeatedly press and flatten the chunks of dough many times so as to deliver the multi-level mouthfeel.

However, even though today's technology has already automated the above process into economical mass production, the automated process is only capable of kneading, cutting, flattening, etc., and the produced cakes is dense, solid, single-layered, and significantly inferior to the hand-made ones which have thin, multiple layers in terms of mouthfeel. To overcome this disadvantage, the automated process requires a mechanism that simulates the manual folding of dough-skin, and the present invention is provided to fulfill this requirement.

### SUMMARY OF THE INVENTION

A major objective of the present invention is to provide two or more folding assemblies above a conveyor belt. When a dough-skin is moved towards the folding assembles on the conveyor belt, the dough-skin's lateral sides are scraped up by spatulas and they are pushed towards the middle by rollers into a loaf of dough having three layers of dough-skin for subsequent processes. The loaf of dough has multi-level mouthfeel similar to one manually made.

Another objective of the present invention is to provide a blower member to a side of each folding assembly. Each blower member contains a pneumatic valve and a pipe. Each pipe is fixedly located to the side of a folding assembly by a positioning element so as to blow air into a gap in the folded dough-skin and as such to achieve a multi-level mouthfeel.

Yet another objective of the present invention is to provide a roller blade in front of the folding assemblies for cutting a wider dough-skin into two regular-sized dough-skins. The regular-sized dough-skins are then moved towards two sets of folding assemblies for automated folding, respectively, and for enhanced productively.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a folding assembly according to an embodiment of the present invention.

FIG. 2 is a perspective diagram showing the folding assembly of FIG. 1 after its assembly.

FIG. 3 is a sectional diagram showing the folding assembly of FIG. 1.

FIG. 4 is a top-view diagram showing the folding assembly of FIG. 1.

FIG. 5 is a perspective diagram showing the folding assembly of FIG. 1 integrated with a blower member.

FIG. 5A is a schematic diagram showing air being blown into the gap between dough-skin layers.

FIG. 6 is a top-view diagram showing an application scenario of the present invention where a dough-skin is folded twice in its shaded areas.

FIG. 7 is a top-view diagram showing another application scenario of the present invention with a wider dough-skin.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

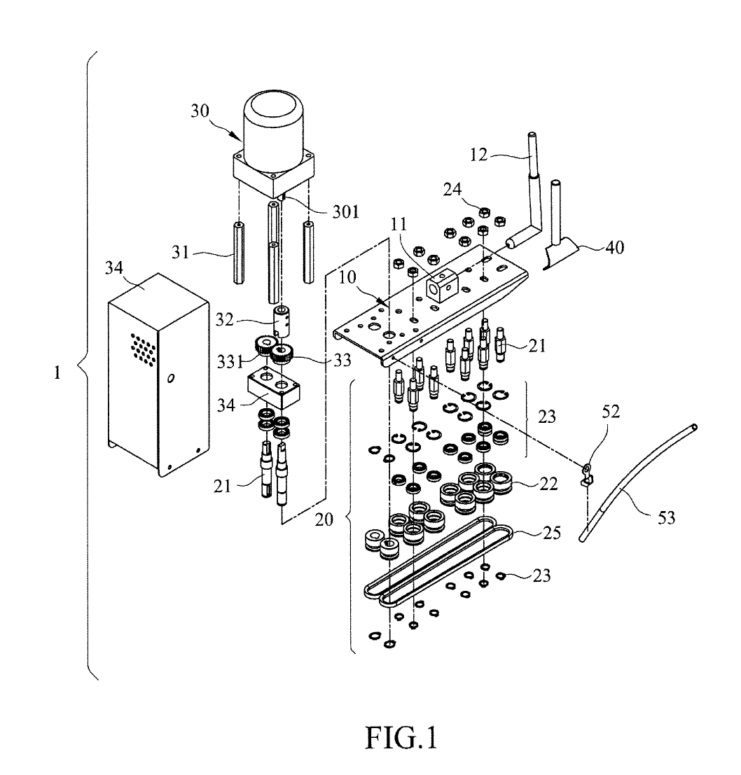

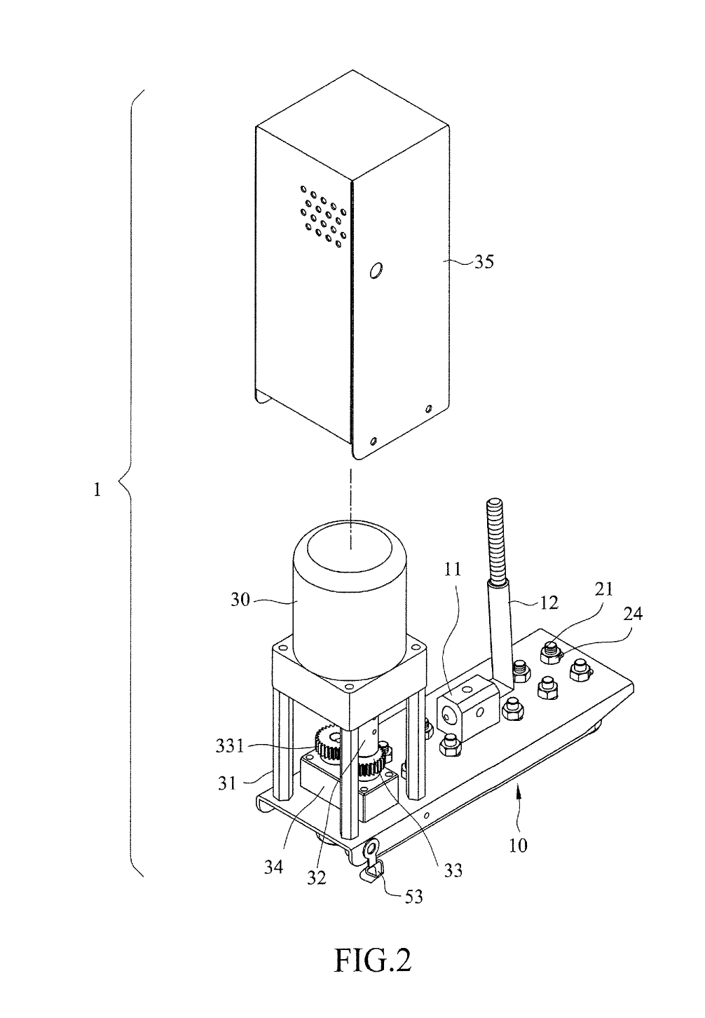

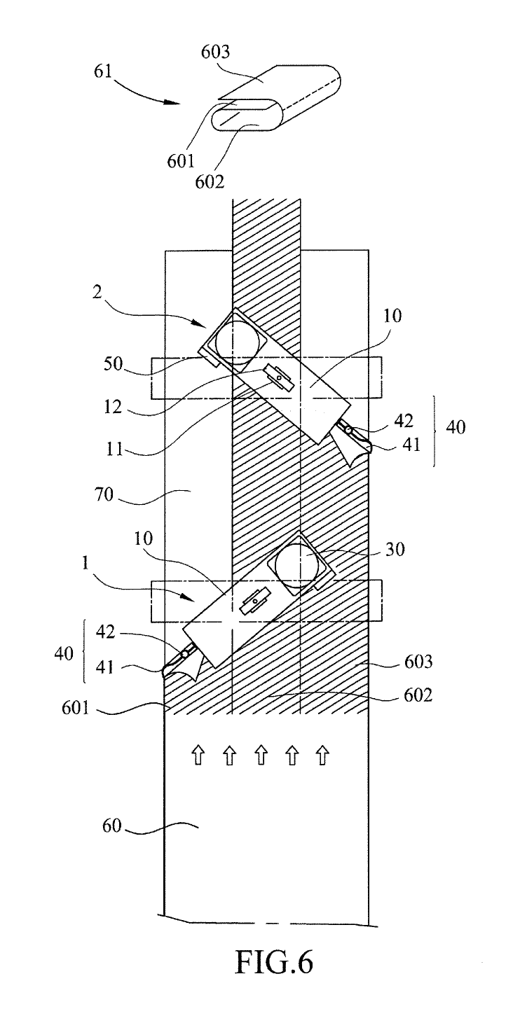

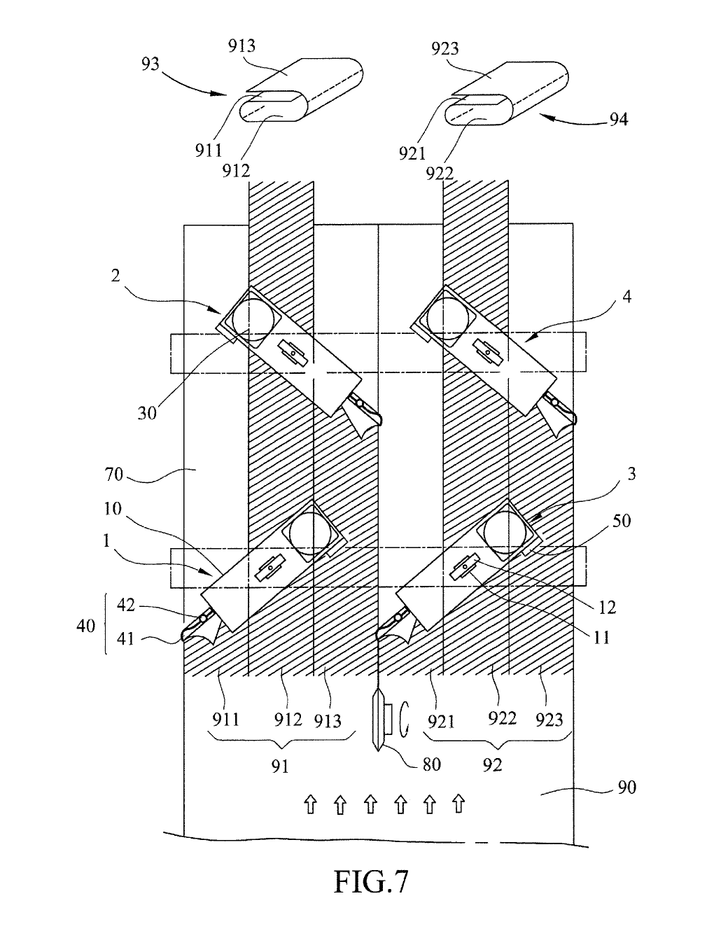

As shown in FIGS. 6 and 7, a dough-skin folding device according to an embodiment of the present invention contains a conveyor belt 70 and two or more folding assemblies 1, 2, 3, and 4 above the conveyor belt 70. The structure of each folding assemblies 1, 2, 3, or 4 is depicted in FIGS. 1 to 3. As illustrated, each folding assembly 1, 2, 3, or 4 contains a base plate 10, a seat 11 on a top side of the base plate 10, and a support element 12 for positioning the folding assembly 1, 2, 3, or 4 above the conveyor belt 70.

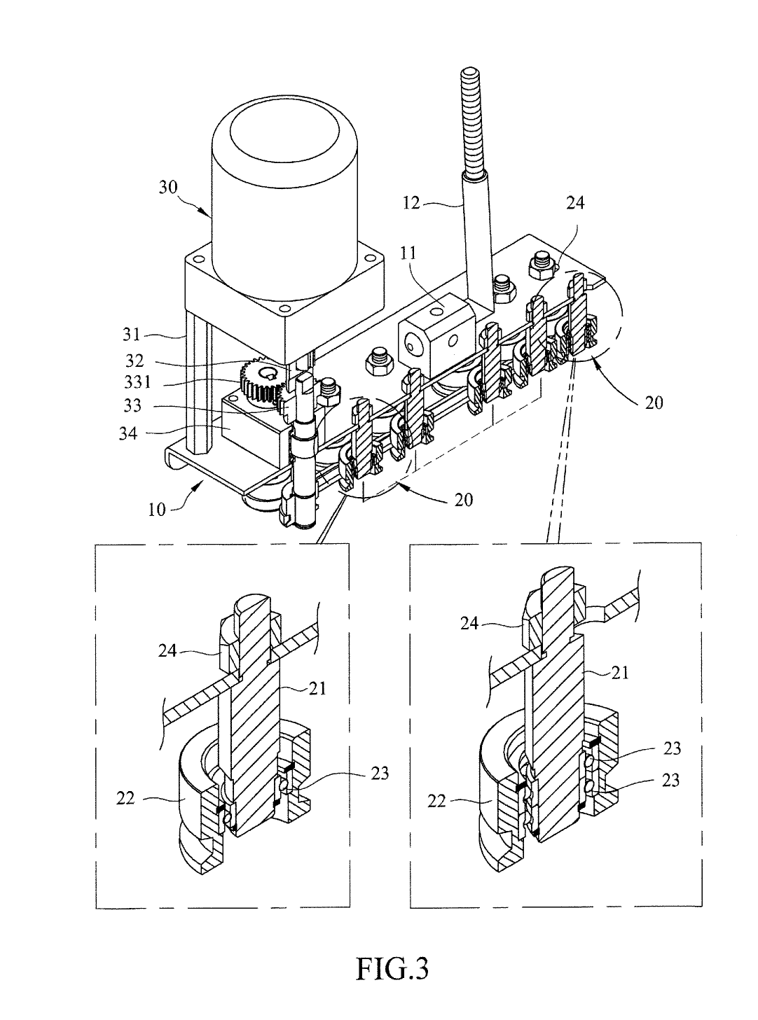

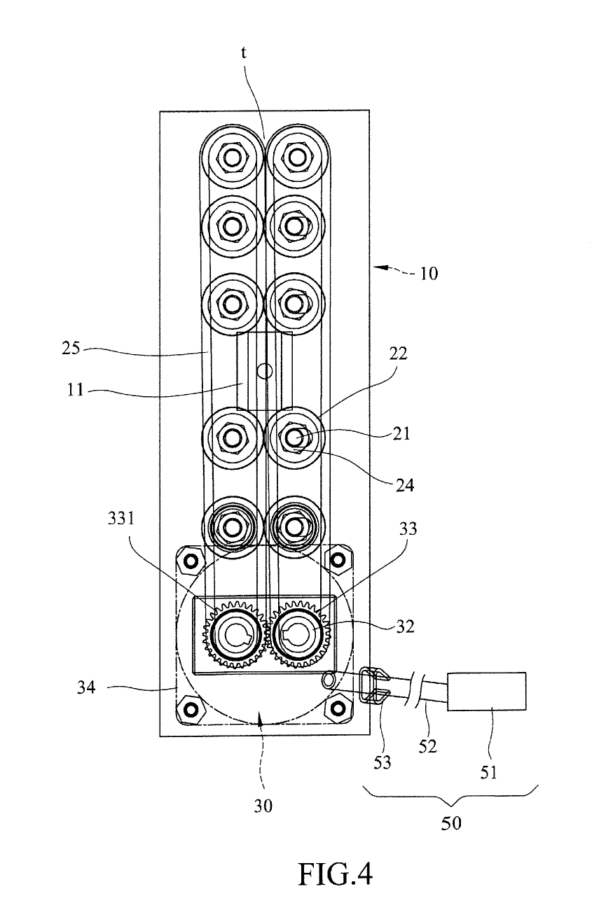

As shown in FIGS. 1, 3, and 4, a transmission member 20 is configured beneath each base plate 10, and contains pairs of shafts 21 arranged in two rows. Each shaft 21 has a top end threaded through the base plate 10 and is fixed to the base plate 10 by a fastening element 24 (e.g., a nut or pin). Under the base plate 10, each shaft 21 has a bottom end engaged by a rotatable roller 22 through at least a bearing set 23. The rollers 22 in the same row are surrounded by a transmission belt 25 so that these rollers 22 spin synchronously. A pair of the rollers 22 at one end of the two rows (e.g., the leftmost pair in FIG. 1) is the driving pair. They make the other rollers 22 on the same rows to spin synchronously through the transmission belts 25, respectively. At least one of the rollers 22 in the pair at the other end of the two rows (e.g., the one enlarged in FIG. 3's lower right) are configured with two bearing sets 23. This roller 22 therefore has the required strength to provide a balanced force for pressing and kneading the dough-skin. A gap t (see FIG. 4) is reserved between the two rows for the dough-skin to be pressed and kneaded.

As shown in FIGS. 1 and 3, a power source 30 (e.g., a motor) is raised on top to an end of the base plate 10 by a number of columns 31. An axle 301 of the power source 30 engages a first roller 22's shaft 21 in the driving pair through a bushing 32. The first roller 22's shaft 21 is threaded through a first gear 33 where a second roller 22 in the driving pair is threaded through a second gear 331 engaged by the first gear 33. Therefore, as the first roller 22 is driven to spin by the power source 30, the second roller 22, and the rest of the rollers 22 in the two rows spin synchronously. To enhance the robustness of the present invention, the first and second gears 33 and 331 are configured on a gear base 34, and the gear base 34, the power source 30, the columns 31, the busing 32, and the gears 33 and 331 are all housed in a casing 35.

As shown in FIGS. 1, 6, and 7, a spatula 40 is positioned in front of an end of each folding assembly 1, 2, 3, or 4. Each spatula 40 contains a curved blade 41 and a support element 42. Each curved blade 41 is positioned so that it is aligned to the gap t between the two rows of rollers 22. Each spatula 40 and its corresponding folding assembly 1, 2, 3, or 4 are positioned at an angle to the moving direction of a dough-skin 60 on the conveyor belt 70.

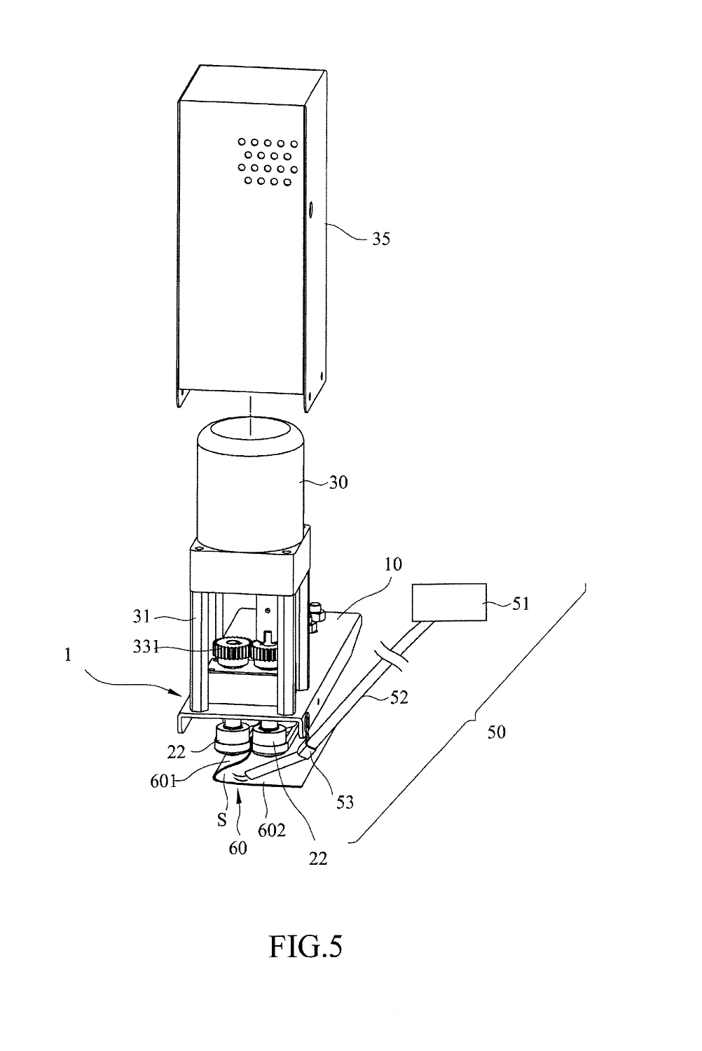

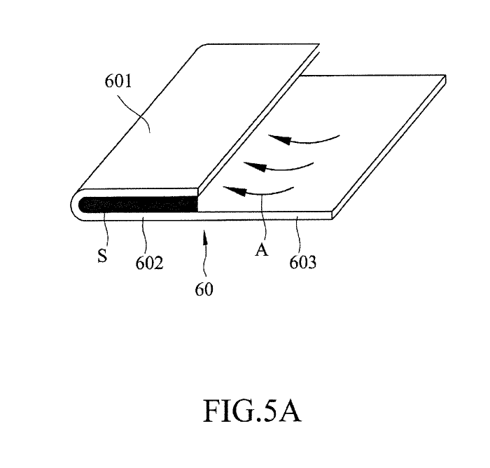

As shown in FIGS. 1, 4, 5, a blower member 50 is positioned to a side of a base plate 10. Each blower member 50 contains a pneumatic valve 51 and a pipe 52. Each pipe 52 is fixedly located to the side of a base plate 10 by a positioning element 53 so as to blow air towards the folded dough-skin 60. As shown in FIGS. 5 and 5A, when the dough-skin 60 is folded, the pneumatic valve 51 pumps air A into a gap S within the folded dough-skin 60 so that the dough-skin 60 delivers a multi-level mouthfeel.

An application scenario of the present invention is depicted in FIGS. 1 and 6. As illustrated, two folding assemblies 1 and 2 are provided above the conveyor belt 70, one in the front and one in the back. Their spatulas 40 are arranged to the lateral sides of the conveyor belt 70, respectively. As the dough-skin 60 is moved towards the folding assemblies 1 and 2, a lateral strip 601 (the left shaded area in FIG. 6) of the dough-skin 60 is scraped up by a first spatula 40 and folded towards a middle strip 602 of the dough-skin 60. Then, a lateral strip 603 on the other lateral side of the dough-skin 60 is scraped up by a second spatula 40 and folded towards the middle strip 602 of the dough-skin 60. A loaf of dough 61 is as such formed to have three layers of the dough-skin 60, as shown in the top part of FIG. 6. The loaf of dough 61 then enters subsequent cutting and kneading processes. However, these processes are outside the scope of the present invention and their details are as such omitted.

As shown in FIG. 7, in another application scenario, a wider dough-skin 90 is cut into two regular-sized dough-skins 91 and 92 by a roller knife 80 as the wider dough-skin 90 is moved along the conveyor belt 70. Two set of folding assemblies 1, 2, 3, and 4 are provided above the dough-skins 91 and 92, and their spatulas 40 are arranged to the lateral sides of the dough-skins 91 and 92, respectively. As the dough-skins 91 and 92 are moved towards the folding assemblies 1, 2, 3, and 4, lateral strips 911 and 921 of the dough-skins 91 and 92 are scraped up by first spatulas 40 and folded towards middle strips 912 and 922 of the dough-skins 91 and 92. Then, lateral strips 913 and 923 on the other lateral sides of the dough-skins 91 and 92 are scraped up by second spatulas 40 and folded towards the middle strips 912 and 922 of the dough-skins 91 and 92. Two loafs of dough 61 are as such formed to have three layers of the dough-skins 91 and 92, as shown in the top part of FIG. 7. The two loafs of dough 61 then enter subsequent cutting and kneading processes.

As described, the present invention is able to fold wider or regular-sized dough-skin into one or more loafs of three-layered dough. The present invention also provides a means to blow air between the layers, and as such achieves enhanced mouthfeel. The present invention automates the dough-skin folding process so as to cut down cost, speed up the manufacturing process, and achieves even better quality.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dough-skin folding device, comprising two or more folding assemblies on top of a conveyor belt, each folding assembly comprising:
a base plate positioned above the conveyor belt by a support element;
a transmission member beneath the base plate comprising a plural pairs of shafts arranged in two rows where each shaft has a top end threaded through and fixed to the base plate by a fastening element, and a bottom end engaged by a rotatable roller through at least a bearing set, and the rollers in the same row are surrounded by a transmission belt so that these rollers spin synchronously, a pair of the rollers at one end of the two rows is the driving pair which make the other rollers on the same rows to spin synchronously through the transmission belts, and a gap is reserved between the two rows for a dough-skin to be pressed and kneaded;
a power source raised on top to an end of the base plate where an axle of the power source engages a first roller in the driving pair through a corresponding first shaft, the first shaft is threaded through a first gear whereas a second roller in the driving pair is threaded through a second gear engaged by the first gear; and
a spatula positioned in front of an end of the folding assembly comprising a curved blade and a support element where the curved blade is positioned so that it is aligned to a gap between the two rows of rollers, and each spatula and corresponding folding assembly are positioned at an angle to the moving direction of the dough-skin on the conveyor belt.

2. The dough-skin folding device according to claim 1, wherein the axle of the power source engages the first shaft through a bushing.

3. The dough-skin folding device according to claim 1, wherein the first and second gears are configured on a gear base; and the gear base, the power source, and the first and second gears are all housed in a casing.

4. The dough-skin folding device according to claim 1, wherein a blower member is positioned to a side of each base plate; each blower member comprises a pneumatic valve and a pipe; and each pipe is fixedly located to the side of a base plate by a positioning element.

5. The dough-skin folding device according to claim 1, wherein a roller blade is configured ahead of the folding assemblies for cutting the dough-skin into halves as the dough-skin is moved towards the folding assemblies.

6. The dough-skin folding device according to claim 5, wherein two sets of folding assemblies are positioned behind the roller blade.
